(19) United States
(12) Patent Application Publication
(10) Pub. No.: US 2026/0300505 A1
(43) Pub. Date: Oct. 1, 2026

(54) GENERATION DEVICE AND GENERATION METHOD

(71) Applicant: Panasonic Automotive Systems Co., Ltd., Kanagawa (JP)

(72) Inventors: Takumaru NAGAI, Osaka (JP); Akihito TAKEUCHI, Osaka (JP); Tomohisa SEZAKI, Kanagawa (JP)

(73) Assignee: Panasonic Automotive Systems Co., Ltd., Kanagawa (JP)

(21) Appl. No.: 19/452,702

(22) Filed: Jan. 19, 2026

(30) Foreign Application Priority Data
Mar. 26, 2025 (JP) 2025-051327

(51) Int. Cl. G06F 21/57

(52) U.S. Cl. CPC G06F 21/577

(57) ABSTRACT

Generation device includes: rule generator that generates an individual rule; rule verifier that verifies whether the individual rule generated by rule generator satisfies the base policy; and rule modifier that modifies the individual rule based on the base policy when the individual rule is verified by rule verifier not to satisfy the base policy. When the individual rule is modified by rule modifier, rule verifier verifies whether the individual rule modified satisfies the base policy. Rule modifier repeatedly modifies the individual rule until the individual rule is verified by rule verifier to satisfy the base policy.

### CROSS REFERENCE TO RELATED APPLICATION

The present application is based on and claims priority of Japanese Patent Application No. 2025-051327 filed on Mar. 26, 2025.

### FIELD

The present disclosure relates to a generation device and a generation method.

### BACKGROUND

Security systems for monitoring communication access within vehicle systems have been known. Integration of vehicle architectures to be applied to such security systems has been progressing from conventional gateway architectures to domain architectures and then to zonal architectures centered on high-performance computers. The integration of the vehicle architectures enables enhanced coordination within the vehicle systems, thus allowing for the realization of more advanced functions.

Furthermore, with developments in Connected, Autonomous, Shared, Electric (CASE) technology, the concept of what is called a Software Defined Vehicle (SDV), in which vehicle functions are defined by software, has been spreading. This allows users to easily add or change vehicle functions by updating the software even after the purchase of the vehicle. On the other hand, the integration of the vehicle architectures may increase security risks because attack points and attack paths that could be targets of attack from the outside increase.

As such, an individual rule between any two partitions into which a vehicle system is logically separated needs to be designed so as to satisfy a base policy about communication access in the entire vehicle system. In association with this, a technique for outputting an error when the individual rule is found not to satisfy the base policy in designing the vehicle system has been known (see Patent Literature (PTL) 1, for example).

### CITATION LIST

### Patent Literature

PTL 1: Japanese Patent No. 5147724

### SUMMARY

The aforementioned conventional technique can be improved upon.

In view of this, the present disclosure provides a generation device and a generation method capable of improving upon the above related art.

A generation device according to one aspect of the present disclosure includes: a rule generator that generates an individual rule about communication access between two partitions among a plurality of partitions into which a vehicle system is logically separated; a rule verifier that verifies, based on a base policy about communication access in all of the plurality of partitions, whether the individual rule generated by the rule generator satisfies the base policy; and a rule modifier that modifies the individual rule based on the base policy when the individual rule is verified by the rule verifier not to satisfy the base policy. When the individual rule is modified by the rule modifier, the rule verifier verifies whether the individual rule modified satisfies the base policy, and the rule modifier repeatedly modifies the individual rule until the individual rule is verified by the rule verifier to satisfy the base policy.

Note that these general or specific aspects may be implemented using a system, a method, an integrated circuit, a computer program, or a computer-readable recording medium such as a Compact Disc-Read Only Memory (CD-ROM), or any combination of systems, methods, integrated circuits, computer programs, and recording media.

According to the generation device, etc. according to one aspect of the present disclosure, the above related art can be further improved upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a generation device according to an embodiment.

FIG. 2 is a flowchart showing a flow of operations of the generation device according to the embodiment.

FIG. 3 is a diagram for explaining the operations of the generation device according to the embodiment.

FIG. 4 is a diagram for explaining the operations of the generation device according to the embodiment.

FIG. 5 is a diagram for explaining the operations of the generation device according to the embodiment.

FIG. 6 is a diagram for explaining the operations of the generation device according to the embodiment.

FIG. 7 is a diagram for explaining the operations of the generation device according to the embodiment.

FIG. 8 is a diagram for explaining the operations of the generation device according to the embodiment.

FIG. 9 is a diagram for explaining the operations of the generation device according to the embodiment.

FIG. 10 is a diagram for explaining the operations of the generation device according to the embodiment.

FIG. 11 is a diagram for explaining the operations of the generation device according to the embodiment.

### DESCRIPTION OF EMBODIMENT

### Underlying Knowledge Forming Basis of the Present Disclosure

The present inventors found that the technique described in “Background” creates a problem as indicated below.

The aforementioned conventional technique creates a problem of complicated work of correcting the individual rule when the individual rule is found not to satisfy the base policy.

To solve such a problem, the inventors conceived a generation device and a generation method indicated below.

### Technique 1

A generation device includes: a rule generator that generates an individual rule about communication access between two partitions among a plurality of partitions into which a vehicle system is logically separated; a rule verifier that verifies, based on a base policy about communication access in all of the plurality of partitions, whether the individual rule generated by the rule generator satisfies the base policy; and a rule modifier that modifies the individual rule based on the base policy when the individual rule is verified by the rule verifier not to satisfy the base policy. When the individual rule is modified by the rule modifier, the rule verifier verifies whether the individual rule modified satisfies the base policy, and the rule modifier repeatedly modifies the individual rule until the individual rule is verified by the rule verifier to satisfy the base policy.

According to Technique 1, the rule verifier verifies, based on the base policy, whether the individual rule generated by the rule generator satisfies the base policy. When the individual rule is verified by the rule verifier not to satisfy the base policy, the rule modifier modifies the individual rule based on the base policy so as to satisfy the base policy. The rule verifier then verifies whether the individual rule modified by the rule modifier satisfies the base policy. In this manner, the rule modifier repeatedly modifies the individual rule until the individual rule is verified by the rule verifier to satisfy the base policy. Thus, the individual rule that satisfies the base policy can be easily generated.

### Technique 2

The generation device according to Technique 1 further includes an outputter that outputs the individual rule to outside of the generation device when the individual rule is verified by the rule verifier to satisfy the base policy.

According to Technique 2, the individual rule verified to satisfy the base policy can be outputted to the outside of the generation device.

### Technique 3

In the generation device according to Technique 1 or 2, when a total number of times the individual rule is verified by the rule verifier not to satisfy the base policy reaches a predetermined number, the rule modifier terminates the modification of the individual rule.

According to Technique 3, the modification of the individual rule can be avoided from being needlessly repeated when the individual rule that satisfies the base policy cannot be generated, for example.

### Technique 4

A generation method includes: (a) generating an individual rule about communication access between two partitions among a plurality of partitions into which a vehicle system is logically separated; (b) verifying, based on a base policy about communication access in all of the plurality of partitions, whether the individual rule generated in (a) satisfies the base policy; (c) modifying, when the individual rule is verified in (b) not to satisfy the base policy, the individual rule based on the base policy; (d) verifying, when the individual rule is modified in (c), whether the individual rule modified satisfies the base policy; and (e) repeatedly modifying the individual rule until the individual rule is verified to satisfy the base policy in (d).

According to Technique 4, the individual rule that satisfies the base policy can be easily generated as with Technique 1.

Note that these general or specific aspects may be implemented using a system, a method, an integrated circuit, a computer program, or a computer-readable recording medium such as a CD-ROM, or any combination of systems, methods, integrated circuits, computer programs, or recording media.

Hereinafter, an embodiment will be specifically described with reference to the drawings.

Note that each of embodiments described below shows a general or specific example. The numerical values, shapes, materials, elements, the arrangement and connection of the elements, steps, the processing order of the steps, etc. shown in the following embodiment are mere examples, and therefore do not limit the scope of the present disclosure. Furthermore, among the elements in the following embodiment, those not recited in the independent claims defining the broadest concept are described as optional elements.

### Embodiment

### 1. Configuration of Generation Device

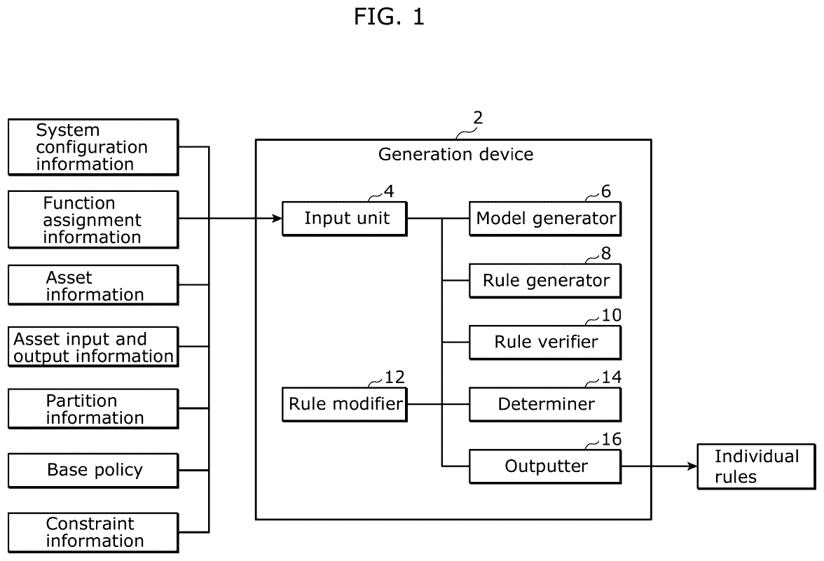

With reference to FIG. 1, a configuration of generation device 2 according to an embodiment will be described. FIG. 1 is a block diagram illustrating the configuration of generation device 2 according to the embodiment.

Generation device 2 according to the embodiment is used, for example, when designing or updating a vehicle system implemented with a vehicle architecture such as a Multiple Independent Levels of Security (MILS) architecture. The vehicle system is installed, for example, in a vehicle such as an automobile and logically separated into a plurality of partitions by a Separation Kernel (SK).

Note that the plurality of partitions include an untrusted partition with a relatively low security level and a trusted partition with a relatively high security level. In other words, the security level of the trusted partition is higher than that of the untrusted partition.

As shown in FIG. 1, generation device 2 includes input unit 4, model generator 6, rule generator 8, rule verifier 10, rule modifier 12, determiner 14, and outputter 16.

For example, system configuration information, function assignment information, asset information, asset input and output information, partition information, a base policy, and constraint information are inputted into input unit 4. Among these, the system configuration information refers to information indicating, for example, the arrangement and connection relationship of Electronic Control Units (ECUs) in the vehicle system, as well as the arrangement and connection relationship of virtual machines in each of the ECUs. The partition information refers to information indicating, for example, the security levels and arrangement of the partitions. The base policy refers to a predefined, unmodifiable, and static policy about communication access in all of the plurality of partitions.

Based on the system configuration information, etc. inputted into input unit 4, model generator 6 generates a model of the vehicle architecture. In this model of the vehicle architecture, a plurality of virtual machines are arranged, for example, and the plurality of virtual machines are logically separated from one another by a plurality of partitions.

Based on the base policy, the constraints, etc. inputted into input unit 4, rule generator 8 generates an individual rule about communication access between any two partitions among the plurality of partitions. Rule generator 8 outputs the generated individual rule to rule verifier 10.

Based on the base policy inputted into input unit 4, rule verifier 10 verifies whether the individual rule generated by rule generator 8 satisfies the base policy. Rule verifier 10 outputs a result of the verification to determiner 14.

Based on the result of the verification by rule verifier 10, determiner 14 outputs the individual rule to either outputter 16 or rule modifier 12. Specifically, when the individual rule is verified by rule verifier 10 to satisfy the base policy, determiner 14 outputs the individual rule to outputter 16. When the individual rule is verified by rule verifier 10 not to satisfy the base policy, determiner 14 outputs the individual rule to rule modifier 12.

When the individual rule is verified by rule verifier 10 not to satisfy the base policy, rule modifier 12 modifies, based on the base policy inputted into input unit 4, the individual rule received from determiner 14 so as to satisfy the base policy. In this case, rule verifier 10 verifies again whether the individual rule modified by rule modifier 12 satisfies the base policy. Note that rule modifier 12 repeatedly modifies the individual rule until the individual rule is verified by rule verifier 10 to satisfy the base policy.

When the individual rule is verified by rule verifier 10 to satisfy the base policy, outputter 16 outputs the individual rule received from determiner 14 to the outside of generation device 2.

### 2. Operations of Generation Device

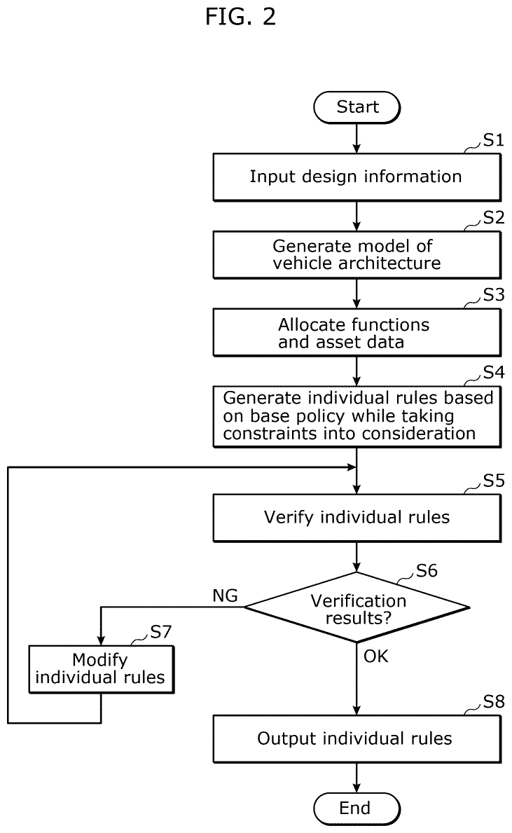

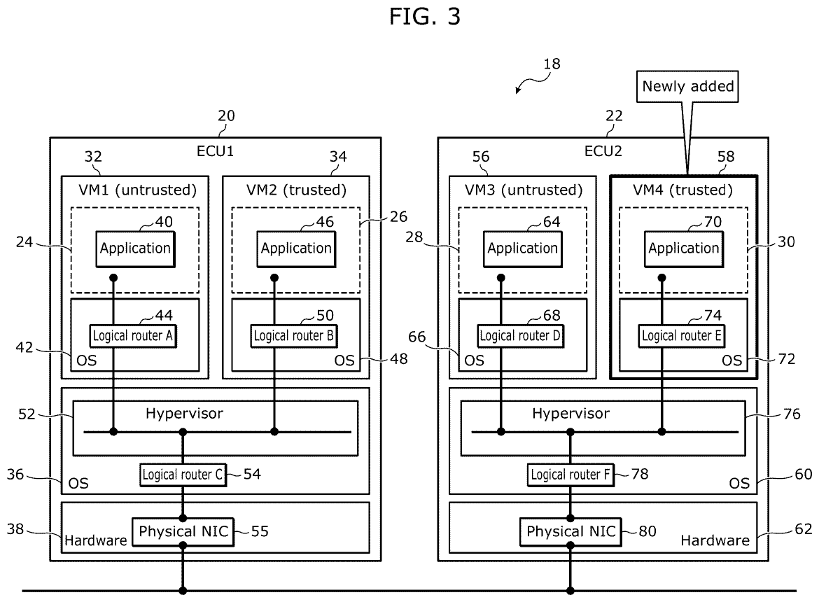

With reference to FIGS. 2 to 11, operations of generation device 2 according to the embodiment will be described next. FIG. 2 is a flowchart showing a flow of the operations of generation device 2 according to the embodiment. FIGS. 3 to 11 are diagrams for explaining the operations of generation device 2 according to the embodiment.

First, design information is inputted into input unit 4 (S1) as shown in FIG. 2. The design information includes the system configuration information, the function assignment information, the asset information, the asset input and output information, the partition information, the base policy, and the constraint information mentioned above.

Next, model generator 6 generates a model of the vehicle architecture based on the system configuration information, etc. included in the design information inputted into input unit 4 (S2). Model generator 6 then allocates functions and asset data onto the generated model of the vehicle architecture (S3).

The model of the vehicle architecture includes, for example, vehicle system 18 shown in FIG. 3. A configuration of vehicle system 18 will now be described. The present embodiment describes a case in which model generator 6 newly adds fourth virtual machine 58 (hereinafter, also referred to as “VM4”) to existing vehicle system 18 including first virtual machine 32 (hereinafter, also referred to as “VM1”), second virtual machine 34 (hereinafter, also referred to as “VM2”), and third virtual machine 56 (hereinafter, also referred to as “VM3”). Note that first virtual machine 32, second virtual machine 34, third virtual machine 56, and fourth virtual machine 58 will be described later.

As shown in FIG. 3, vehicle system 18 includes first ECU 20 (hereinafter, also referred to as “ECU1”) and second ECU 22 (hereinafter, also referred to as “ECU 2”). Vehicle system 18 is logically separated into first partition 24, second partition 26, third partition 28, and fourth partition 30.

Each of first partition 24 and third partition 28 is an untrusted partition with a relatively low security level and includes, for example, a region having a function of connecting the vehicle to the outside world via the Internet. Each of second partition 26 and fourth partition 30, on the other hand, is a trusted partition with a relatively high security level and includes, for example, a region having important functions of the vehicle such as running, turning, and stopping. In other words, the security levels of second partition 26 and fourth partition 30 are higher than those of first partition 24 and third partition 28.

First ECU 20 includes first virtual machine 32, second virtual machine 34, operating system (OS) 36, and hardware 38.

First virtual machine 32 is a virtual machine that runs on hypervisor 52 (described later). First virtual machine 32 includes application 40 and logical router 44 (hereinafter, also referred to as “logical router A”) that runs on operating system 42.

Application 40 is an application program that runs on operating system 42, and is included in first partition 24.

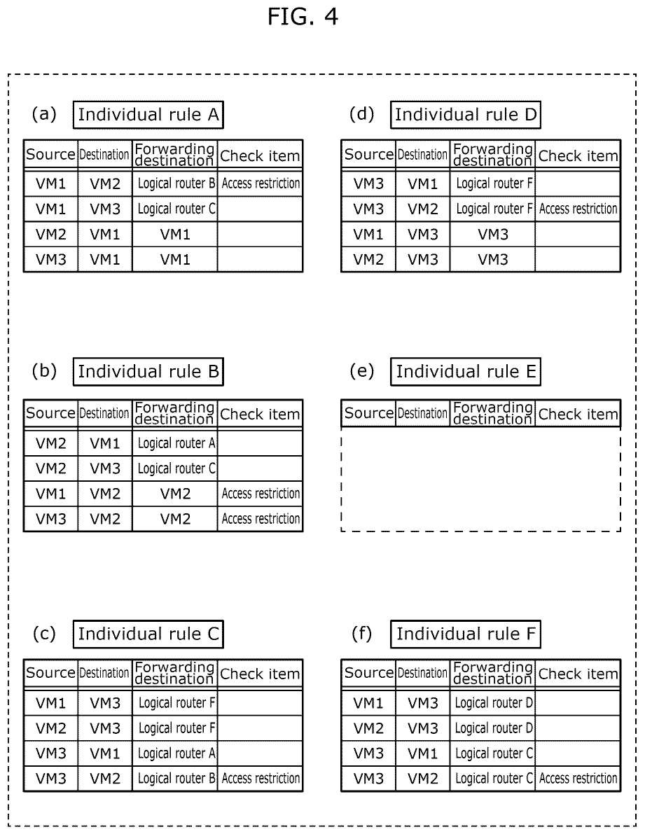

Logical router 44 is a virtual router implemented by software. Based on individual rule A in the form of a table shown in (a) of FIG. 4, logical router 44 controls communication access between two virtual machines among first virtual machine 32, second virtual machine 34, and third virtual machine 56.

Individual rule A is a rule about communication access between two virtual machines among first virtual machine 32, second virtual machine 34, and third virtual machine 56, i.e., communication access between two partitions among first partition 24, second partition 26, and third partition 28. Individual rule A shown in (a) of FIG. 4 is an existing individual rule, which already existed when model generator 6 newly added fourth virtual machine 58 to vehicle system 18. Thus, communication access using fourth virtual machine 58 as a source, a destination, or a forwarding destination has not been specified yet. This applies also to individual rules B to F to be described later.

As shown in (a) of FIG. 4, individual rule A is a rule specifying that: (i) communication access from a virtual machine including a trusted partition to a virtual machine including an untrusted partition is permitted; (ii) communication access from a virtual machine including an untrusted partition to a virtual machine including an untrusted partition is permitted; and (iii) communication access from a virtual machine including an untrusted partition to a virtual machine including a trusted partition is restricted. More specifically, as shown in (a) of FIG. 4, individual rule A is a rule that specifies the source, destination, and forwarding destination of communication access, and also specifies whether the communication access is restricted as a check item. This also applies to individual rules B to F to be described later.

As shown in (a) of FIG. 4, the first row in individual rule A specifies a rule that “communication access using VM1 as a source, VM2 as a destination, and logical router B (described later) as a forwarding destination is restricted”. Furthermore, the second row in individual rule A specifies a rule that “communication access using VM1 as a source, VM3 as a destination, and logical router C (described later) as a forwarding destination is permitted”. Furthermore, the third row in individual rule A specifies a rule that “communication access using VM2 as a source, and VM1 as a destination and a forwarding destination is permitted”. Furthermore, the fourth row in individual rule A specifies a rule that “communication access using VM3 as a source, and VM1 as a destination and a forwarding destination is permitted”.

Second virtual machine 34 is a virtual machine that runs on hypervisor 52. Second virtual machine 34 includes application 46 and logical router 50 (hereinafter, also referred to as “logical router B”) that runs on operating system 48.

Application 46 is an application program that runs on operating system 48, and is included in second partition 26.

Logical router 50 is a virtual router implemented by software. Based on individual rule B in the form of a table shown in (b) of FIG. 4, logical router 50 controls communication access between two virtual machines among first virtual machine 32, second virtual machine 34, and third virtual machine 56.

As shown in (b) of FIG. 4, the first row in individual rule B specifies a rule that “communication access using VM2 as a source, VM1 as a destination, and logical router A as a forwarding destination is permitted”. Furthermore, the second row in individual rule B specifies a rule that “communication access using VM2 as a source, VM3 as a destination, and logical router C as a forwarding destination is permitted”. Furthermore, the third row in individual rule B specifies a rule that “communication access using VM1 as a source, and VM2 as a destination and a forwarding destination is restricted”. Furthermore, the fourth row in individual rule B specifies a rule that “communication access using VM3 as a source, and VM2 as a destination and a forwarding destination is restricted”.

Operating system 36 is an operating system that runs on hardware 38. Operating system 36 includes hypervisor 52 and logical router 54 (hereinafter, also referred to as “logical router C”).

Hypervisor 52 is virtualization software that runs on hardware 38 and controls the execution of first virtual machine 32 and second virtual machine 34.

Logical router 54 is a virtual router implemented by software. Based on individual rule C in the form of a table shown in (c) of FIG. 4, logical router 54 controls communication access between two virtual machines among first virtual machine 32, second virtual machine 34, and third virtual machine 56.

As shown in (c) of FIG. 4, the first row in individual rule C specifies a rule that “communication access using VM1 as a source, VM3 as a destination, and logical router F (described later) as a forwarding destination is permitted”. Furthermore, the second row in individual rule C specifies a rule that “communication access using VM2 as a source, VM3 as a destination, and logical router F as a forwarding destination is permitted”. Furthermore, the third row in individual rule C specifies a rule that “communication access using VM3 as a source, VM1 as a destination, and logical router A as a forwarding destination is permitted”. Furthermore, the fourth row in individual rule C specifies a rule that “communication access using VM3 as a source, VM2 as a destination, and logical router B as a forwarding destination is restricted”.

Hardware 38 is hardware for providing an execution environment for a plurality of computer programs, and is implemented with a System on a Chip (SoC), for example. Hardware 38 includes physical Network Interface Card (NIC) 55 for connecting first ECU 20 to an in-vehicle network.

Second ECU 22 includes third virtual machine 56, fourth virtual machine 58, operating system 60, and hardware 62.

Third virtual machine 56 is a virtual machine that runs on hypervisor 76 (described later). Third virtual machine 56 includes application 64 and logical router 68 (hereinafter, also referred to as “logical router D”) that runs on operating system 66.

Application 64 is an application program that runs on operating system 66, and is included in third partition 28.

Logical router 68 is a virtual router implemented by software. Based on individual rule D in the form of a table shown in (d) of FIG. 4, logical router 68 controls communication access between two virtual machines among first virtual machine 32, second virtual machine 34, and third virtual machine 56.

As shown in (d) of FIG. 4, the first row in individual rule D specifies a rule that “communication access using VM3 as a source, VM1 as a destination, and logical router F as a forwarding destination is permitted”. Furthermore, the second row in individual rule D specifies a rule that “communication access using VM3 as a source, VM2 as a destination, and logical router F as a forwarding destination is restricted”. Furthermore, the third row in individual rule D specifies a rule that “communication access using VM1 as a source, and VM3 as a destination and a forwarding destination is permitted”. Furthermore, the fourth row in individual rule D specifies a rule that “communication access using VM2 as a source, and VM3 as a destination and a forwarding destination is permitted”.

Fourth virtual machine 58 is a virtual machine that runs on hypervisor 76. Fourth virtual machine 58 includes application 70 and logical router 74 (hereinafter, also referred to as “logical router E”) that runs on operating system 72.

Application 70 is an application program that runs on operating system 72, and is included in fourth partition 30.

Logical router 74 is a virtual router implemented by software. Based on individual rule E in the form of a table shown in (e) of FIG. 4, logical router 74 controls communication access between two virtual machines among first virtual machine 32, second virtual machine 34, and third virtual machine 56. Note that individual rule E has not been generated yet as of step S3 in the flowchart of FIG. 2.

Operating system 60 is an operating system that runs on hardware 62. Operating system 60 includes hypervisor 76 and logical router 78 (hereinafter, also referred to as “logical router F”).

Hypervisor 76 is virtualization software that runs on hardware 62 and controls the execution of third virtual machine 56 and fourth virtual machine 58.

Logical router 78 is a virtual router implemented by software. Based on individual rule F in the form of a table shown in (f) of FIG. 4, logical router 78 controls communication access between two virtual machines among first virtual machine 32, second virtual machine 34, and third virtual machine 56.

As shown in (f) of FIG. 4, the first row in individual rule F specifies a rule that “communication access using VM1 as a source, VM3 as a destination, and logical router D as a forwarding destination is permitted”. Furthermore, the second row in individual rule F specifies a rule that “communication access using VM2 as a source, VM3 as a destination, and logical router D as a forwarding destination is permitted”. Furthermore, the third row in individual rule F specifies a rule that “communication access using VM3 as a source, VM1 as a destination, and logical router C as a forwarding destination is permitted”. Furthermore, the fourth row in individual rule F specifies a rule that “communication access using VM3 as a source, VM2 as a destination, and logical router C as a forwarding destination is restricted”.

Hardware 62 is hardware for providing an execution environment for a plurality of computer programs, and is implemented with an SoC, for example. Hardware 62 includes physical NIC 80 for connecting second ECU 22 to the in-vehicle network.

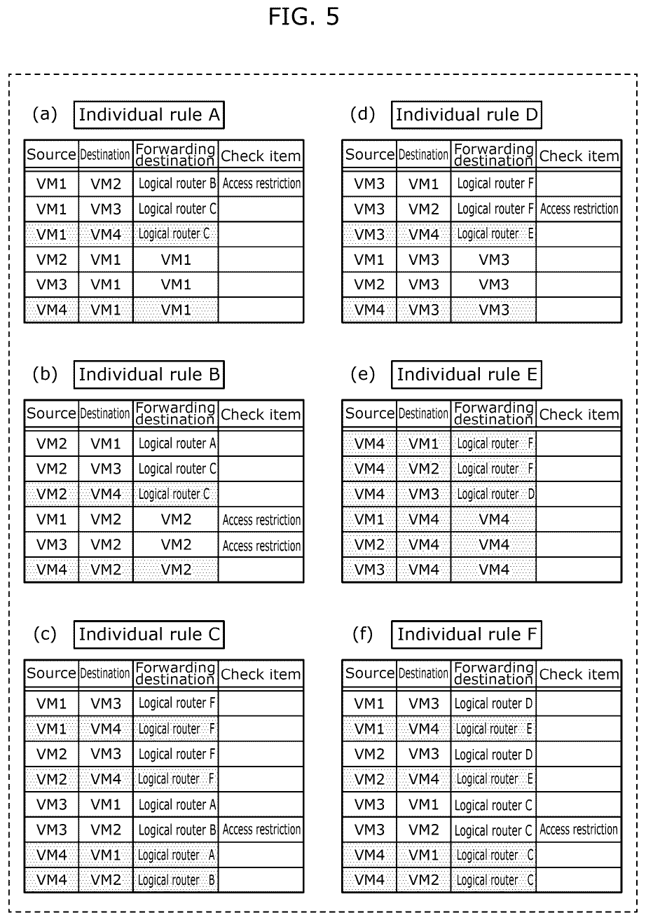

Referring back to the flowchart of FIG. 2, after step S3, rule generator 8 generates individual rules A to F shown in (a) to (f) of FIG. 5, respectively, based on the base policy inputted into input unit 4, while taking into consideration the constraints inputted into input unit 4 (S4). Specifically, rule generator 8 adds rules about communication access using VM4 as a source, a destination, or a forwarding destination in each of tables for individual rules A to F as indicated by hatching in (a) to (f) of FIG. 5.

As shown in (a) of FIG. 5, in the third row in individual rule A, rule generator 8 newly adds a rule that “communication access using VM1 as a source, VM4 as a destination, and logical router C as a forwarding destination is permitted”. Furthermore, in the sixth row in individual rule A, rule generator 8 newly adds a rule that “communication access using VM4 as a source, and VM1 as a destination and a forwarding destination is permitted”.

As shown in (b) of FIG. 5, in the third row in individual rule B, rule generator 8 newly adds a rule that “communication access using VM2 as a source, VM4 as a destination, and logical router C as a forwarding destination is permitted”. Furthermore, in the sixth row in individual rule B, rule generator 8 newly adds a rule that “communication access using VM4 as a source, and VM2 as a destination and a forwarding destination is permitted”.

As shown in (c) of FIG. 5, in the second row in individual rule C, rule generator 8 newly adds a rule that “communication access using VM1 as a source, VM4 as a destination, and logical router F as a forwarding destination is permitted”. Furthermore, in the fourth row in individual rule C, rule generator 8 newly adds a rule that “communication access using VM2 as a source, VM4 as a destination, and logical router F as a forwarding destination is permitted”. Furthermore, in the seventh row in individual rule C, rule generator 8 newly adds a rule that “communication access using VM4 as a source, VM1 as a destination, and logical router A as a forwarding destination is permitted”. Furthermore, in the eighth row in individual rule C, rule generator 8 newly adds a rule that “communication access using VM4 as a source, VM2 as a destination, and logical router B as a forwarding destination is permitted”.

As shown in (d) of FIG. 5, in the third row in individual rule D, rule generator 8 newly adds a rule that “communication access using VM3 as a source, VM4 as a destination, and logical router E as a forwarding destination is permitted”. Furthermore, in the sixth row in individual rule D, rule generator 8 newly adds a rule that “communication access using VM4 as a source, and VM3 as a destination and a forwarding destination is permitted”.

As shown in (e) of FIG. 5, in the first row in individual rule E, rule generator 8 newly adds a rule that “communication access using VM4 as a source, VM1 as a destination, and logical router F as a forwarding destination is permitted”. Furthermore, in the second row in individual rule E, rule generator 8 newly adds a rule that “communication access using VM4 as a source, VM2 as a destination, and logical router F as a forwarding destination is permitted”. Furthermore, in the third row in individual rule E, rule generator 8 newly adds a rule that “communication access using VM4 as a source, VM3 as a destination, and logical router D as a forwarding destination is permitted”. Furthermore, in the fourth row in individual rule E, rule generator 8 newly adds a rule that “communication access using VM1 as a source, and VM4 as a destination and a forwarding destination is permitted”. Furthermore, in the fifth row in individual rule E, rule generator 8 newly adds a rule that “communication access using VM2 as a source, and VM4 as a destination and a forwarding destination is permitted”. Furthermore, in the sixth row in individual rule E, rule generator 8 newly adds a rule that “communication access using VM3 as a source, and VM4 as a destination and a forwarding destination is permitted”.

As shown in (f) of FIG. 5, in the second row in individual rule F, rule generator 8 newly adds a rule that “communication access using VM1 as a source, VM4 as a destination, and logical router E as a forwarding destination is permitted”. Furthermore, in the fourth row in individual rule F, rule generator 8 newly adds a rule that “communication access using VM2 as a source, VM4 as a destination, and logical router E as a forwarding destination is permitted”. Furthermore, in the seventh row in individual rule F, rule generator 8 newly adds a rule that “communication access using VM4 as a source, VM1 as a destination, and logical router C as a forwarding destination is permitted”. Furthermore, in the eighth row in individual rule F, rule generator 8 newly adds a rule that “communication access using VM4 as a source, VM2 as a destination, and logical router C as a forwarding destination is permitted”.

Referring back to the flowchart of FIG. 2, after step S4, rule verifier 10 verifies, based on the base policy inputted into input unit 4, whether individual rules A to F generated by rule generator 8 satisfy the base policy (S5).

In the present embodiment, the base policy specifies that: (a) communication access from a trusted partition to an untrusted partition is unrestricted; (b) communication access from an untrusted partition to a trusted partition is restricted; and (c) communication access between trusted partitions is prohibited in plaintext (encryption is required).

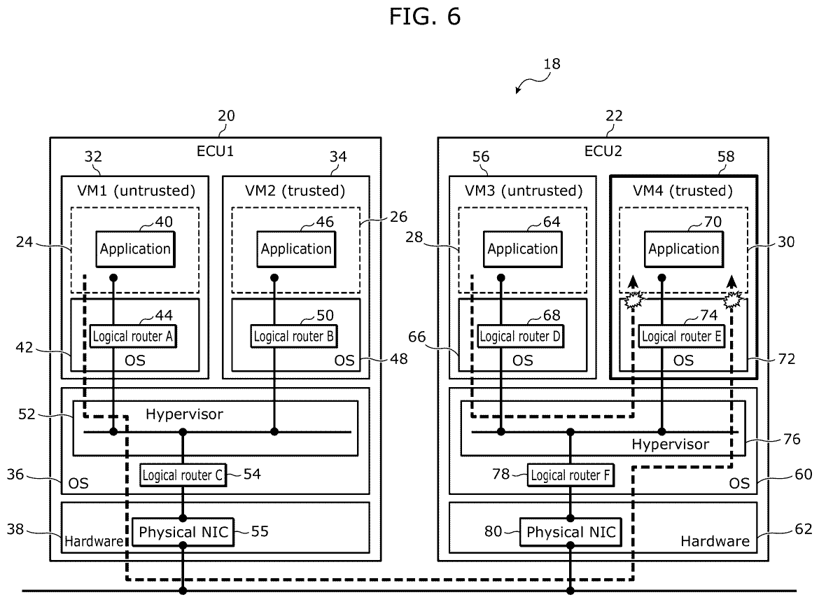

Here, as shown in FIG. 6, communication access from first virtual machine 32 to fourth virtual machine 58 corresponds to communication access from an untrusted partition (first partition 24) to a trusted partition (fourth partition 30). Also, communication access from third virtual machine 56 to fourth virtual machine 58 corresponds to communication access from an untrusted partition (third partition 28) to a trusted partition (fourth partition 30).

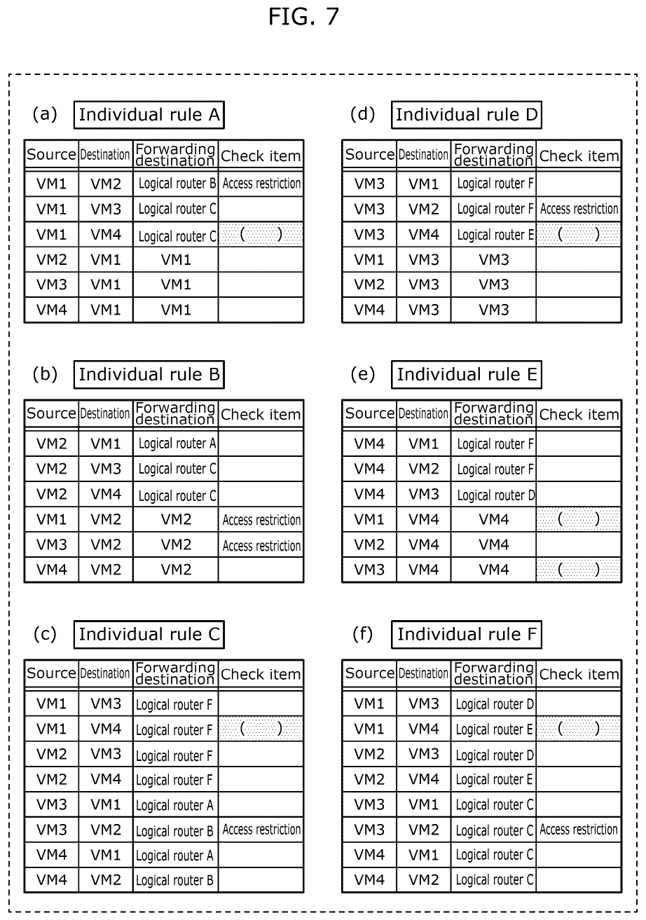

Therefore, the rule that “communication access using VM1 as a source, VM4 as a destination, and logical router C as a forwarding destination is permitted” in the third row in individual rule A shown in (a) of FIG. 7 is verified by rule verifier 10 not to satisfy the above-described base policy specifying that “(b) communication access from an untrusted partition to a trusted partition is restricted”. Note that in the third row in individual rule A shown in (a) of FIG. 7, the check item that does not satisfy the base policy is indicated by hatching.

Furthermore, the rule that “communication access using VM1 as a source, VM4 as a destination, and logical router F as a forwarding destination is permitted” in the second row in individual rule C shown in (c) of FIG. 7 is verified by rule verifier 10 not to satisfy the above-described base policy specifying that “(b) communication access from an untrusted partition to a trusted partition is restricted”. Note that in the second row in individual rule C shown in (c) of FIG. 7, the check item that does not satisfy the base policy is indicated by hatching.

Furthermore, the rule that “communication access using VM3 as a source, VM4 as a destination, and logical router E as a forwarding destination is permitted” in the third row in individual rule D shown in (d) of FIG. 7 is verified by rule verifier 10 not to satisfy the above-described base policy specifying that “(b) communication access from an untrusted partition to a trusted partition is restricted”. Note that in the third row in individual rule D shown in (d) of FIG. 7, the check item that does not satisfy the base policy is indicated by hatching.

Furthermore, the rule that “communication access using VM1 as a source, and VM4 as a destination and a forwarding destination is permitted” in the fourth row in individual rule E shown in (e) of FIG. 7 is verified by rule verifier 10 not to satisfy the above-described base policy specifying that “(b) communication access from an untrusted partition to a trusted partition is restricted”. Furthermore, the rule that “communication access using VM3 as a source, and VM4 as a destination and a forwarding destination is permitted” in the sixth row in individual rule E is verified by rule verifier 10 not to satisfy the above-described base policy specifying that “(b) communication access from an untrusted partition to a trusted partition is restricted”. Note that in each of the fourth row and the sixth row in individual rule E shown in (e) of FIG. 7, the check item that does not satisfy the base policy is indicated by hatching.

Furthermore, the rule that “communication access using VM1 as a source, VM4 as a destination, and logical router E as a forwarding destination is permitted” in the second row in individual rule F shown in (f) of FIG. 7 is verified by rule verifier 10 not to satisfy the above-described base policy specifying that “(b) communication access from an untrusted partition to a trusted partition is restricted”. Note that in the second row in individual rule F shown in (f) of FIG. 7, the check item that does not satisfy the base policy is indicated by hatching.

Referring back to the flowchart of FIG. 2, when individual rules A, and C to F are verified by rule verifier 10 not to satisfy the base policy (“NG” in S6), determiner 14 outputs individual rules A, and C to F to rule modifier 12 based on the verification results of rule verifier 10. Rule modifier 12 then modifies, based on the base policy inputted into input unit 4, individual rules A, and C to F so as to satisfy the base policy (S7).

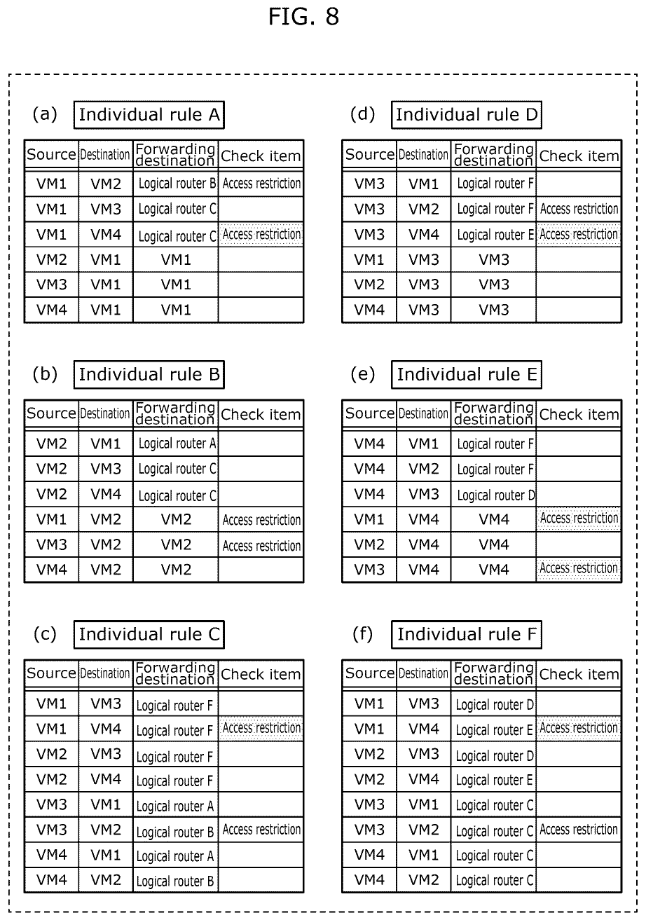

Specifically, in the third row in individual rule A shown in (a) of FIG. 8, as to the rule that “communication access using VM1 as a source, VM4 as a destination, and logical router C as a forwarding destination is permitted”, rule modifier 12 modifies the check item in this rule to “access restriction” so as to satisfy the above-described base policy specifying that “(b) communication access from an untrusted partition to a trusted partition is restricted”. As a result, the third row in individual rule A is modified to specify a rule that “communication access using VM1 as a source, VM4 as a destination, and logical router C as a forwarding destination is restricted”. Note that in the third row in individual rule A shown in (a) of FIG. 8, the modified check item is indicated by hatching.

Furthermore, in the second row in individual rule C shown in (c) of FIG. 8, as to the rule that “communication access using VM1 as a source, VM4 as a destination, and logical router F as a forwarding destination is permitted”, rule modifier 12 modifies the check item in this rule to “access restriction” so as to satisfy the above-described base policy specifying that “(b) communication access from an untrusted partition to a trusted partition is restricted”. As a result, the second row in individual rule C is modified to specify a rule that “communication access using VM1 as a source, VM4 as a destination, and logical router F as a forwarding destination is restricted”. Note that in the second row in individual rule C shown in (c) of FIG. 8, the modified check item is indicated by hatching.

Furthermore, in the third row in individual rule D shown in (d) of FIG. 8, as to the rule that “communication access using VM3 as a source, VM4 as a destination, and logical router E as a forwarding destination is permitted”, rule modifier 12 modifies the check item in this rule to “access restriction” so as to satisfy the above-described base policy specifying that “(b) communication access from an untrusted partition to a trusted partition is restricted”. As a result, the third row in individual rule D is modified to specify a rule that “communication access using VM3 as a source, VM4 as a destination, and logical router E as a forwarding destination is restricted”. Note that in the third row in individual rule D shown in (d) of FIG. 8, the modified check item is indicated by hatching.

Furthermore, in the fourth row in individual rule E shown in (e) of FIG. 8, as to the rule that “communication access using VM1 as a source, and VM4 as a destination and a forwarding destination is permitted”, rule modifier 12 modifies the check item in this rule to “access restriction” so as to satisfy the above-described base policy specifying that “(b) communication access from an untrusted partition to a trusted partition is restricted”. As a result, the fourth row in individual rule E is modified to specify a rule that “communication access using VM1 as a source, and VM4 as a destination and a forwarding destination is restricted”. Furthermore, in the sixth row in individual rule E, as to the rule that “communication access using VM3 as a source, and VM4 as a destination and a forwarding destination is permitted”, rule modifier 12 modifies the check item in this rule to “access restriction” so as to satisfy the above-described base policy specifying that “(b) communication access from an untrusted partition to a trusted partition is restricted”. As a result, the sixth row in individual rule E is modified to specify a rule that “communication access using VM3 as a source, and VM4 as a destination and a forwarding destination is restricted”. Note that in each of the fourth row and the sixth row in individual rule E shown in (e) of FIG. 8, the modified check item is indicated by hatching.

Furthermore, in the second row in individual rule F shown in (f) of FIG. 8, as to the rule that “communication access using VM1 as a source, VM4 as a destination, and logical router E as a forwarding destination is permitted”, rule modifier 12 modifies the check item in this rule to “access restriction” so as to satisfy the above-described base policy specifying that “(b) communication access from an untrusted partition to a trusted partition is restricted”. As a result, the second row in individual rule F is modified to specify a rule that “communication access using VM1 as a source, VM4 as a destination, and logical router E as a forwarding destination is restricted”. Note that in the second row in individual rule F shown in (f) of FIG. 8, the modified check item is indicated by hatching.

Referring back to the flowchart of FIG. 2, the process proceeds to step S5 after step S7, and rule verifier 10 verifies again, based on the base policy, whether individual rules A to F shown in (a) to (f) of FIG. 8, respectively, which have been modified by rule modifier 12, satisfy the base policy (S5).

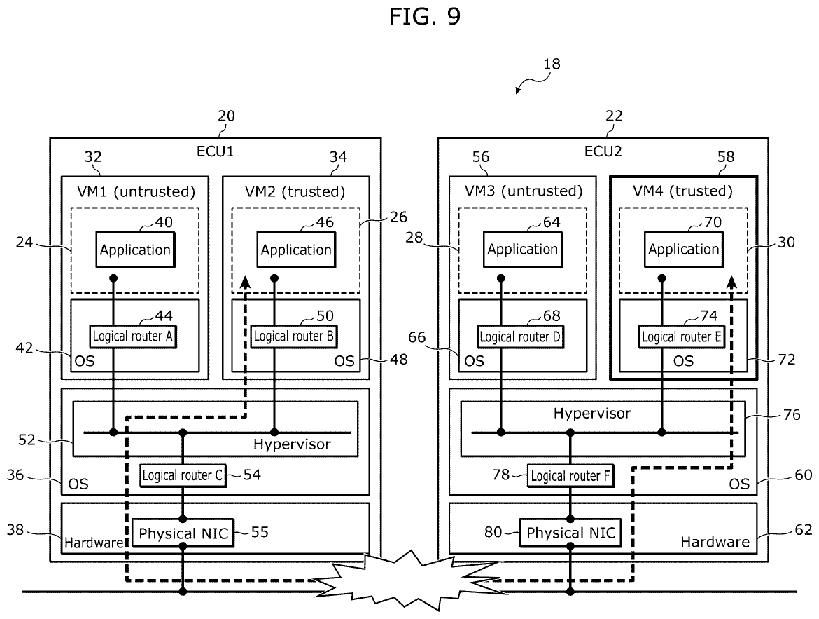

Here, as shown in FIG. 9, communication access between second virtual machine 34 and fourth virtual machine 58 corresponds to communication access between a trusted partition (second partition 26) and a trusted partition (fourth partition 30).

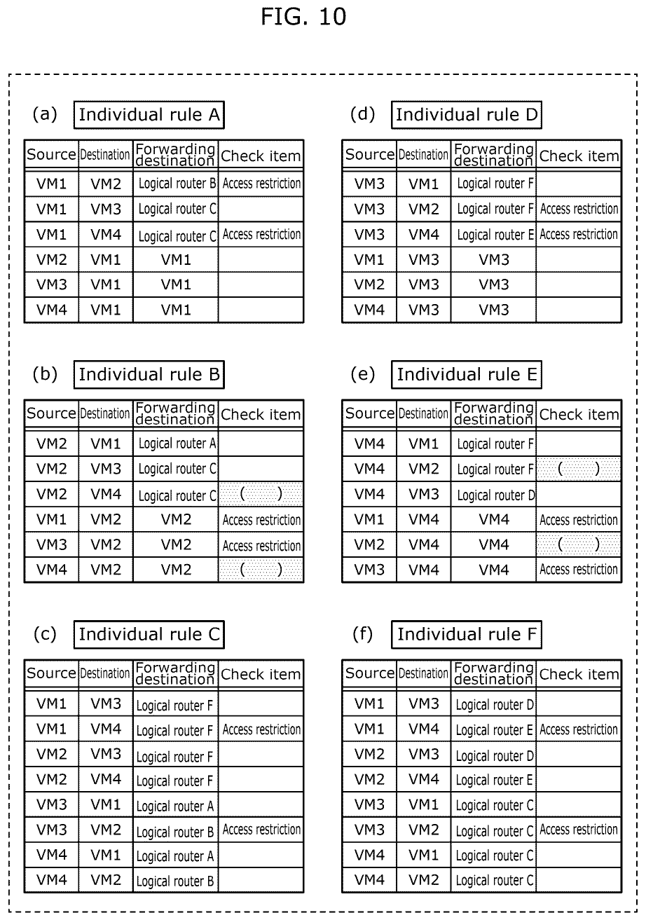

Therefore, the rule that “communication access using VM2 as a source, VM4 as a destination, and logical router C as a forwarding destination is permitted” in the third row in individual rule B shown in (b) of FIG. 10 is verified by rule verifier 10 not to satisfy the above-described base policy specifying that “(c) communication access between trusted partitions is prohibited in plaintext (encryption is required)”. Furthermore, the rule that “communication access using VM4 as a source, and VM2 as a destination and a forwarding destination is permitted” in the sixth row in individual rule B is verified by rule verifier 10 not to satisfy the above-described base policy specifying that “(c) communication access between trusted partitions is prohibited in plaintext (encryption is required)”. Note that in each of the third row and the sixth row in individual rule B shown in (b) of FIG. 10, the check item that does not satisfy the base policy is indicated by hatching.

Furthermore, the rule that “communication access using VM4 as a source, VM2 as a destination, and logical router F as a forwarding destination is permitted” in the second row in individual rule E shown in (e) of FIG. 10 is verified by rule verifier 10 not to satisfy the above-described base policy specifying that “(c) communication access between trusted partitions is prohibited in plaintext (encryption is required)”. Furthermore, the rule that “communication access using VM2 as a source, and VM4 as a destination and a forwarding destination is permitted” in the fifth row in individual rule E is verified by rule verifier 10 not to satisfy the above-described base policy specifying that “(c) communication access between trusted partitions is prohibited in plaintext (encryption is required)”. Note that in each of the second row and the fifth row in individual rule E shown in (e) of FIG. 10, the check item that does not satisfy the base policy is indicated by hatching.

Referring back to the flowchart of FIG. 2, when individual rules B and E are verified by rule verifier 10 not to satisfy the base policy (“NG” in S6), determiner 14 outputs individual rules B and E to rule modifier 12 based on the verification results of rule verifier 10. Rule modifier 12 then modifies, based on the base policy, individual rules B and E so as to satisfy the base policy (S7).

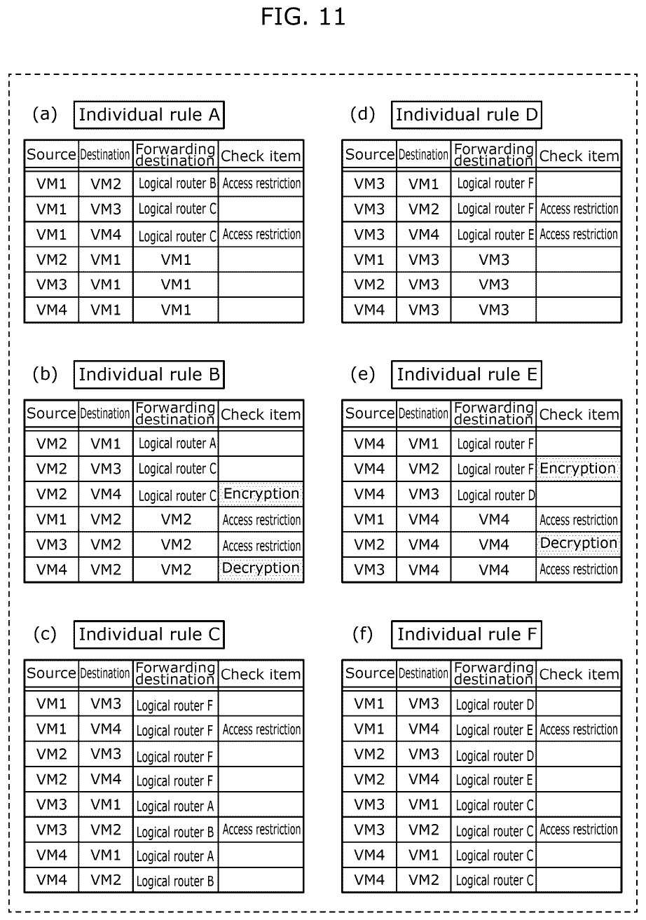

Specifically, in the third row in individual rule B shown in (b) of FIG. 11, as to the rule that “communication access using VM2 as a source, VM4 as a destination, and logical router C as a forwarding destination is permitted”, rule modifier 12 modifies the check item in this rule to “encryption” so as to satisfy the above-described base policy specifying that “(c) communication access between trusted partitions is prohibited in plaintext (encryption is required)”. As a result, the third row in individual rule B is modified to specify a rule that “communication access using VM2 as a source, VM4 as a destination, and logical router C as a forwarding destination is prohibited in plaintext”. Furthermore, in the sixth row in individual rule B, as to the rule that “communication access using VM4 as a source, and VM2 as a destination and a forwarding destination is permitted”, rule modifier 12 modifies the check item in this rule to “decryption” so as to satisfy the above-described base policy specifying that “(c) communication access between trusted partitions is prohibited in plaintext (encryption is required)”. As a result, the sixth row in individual rule B is modified to specify a rule that “communication access using VM4 as a source, and VM2 as a destination and a forwarding destination is prohibited in plaintext”. Note that in each of the third row and the sixth row in individual rule B shown in (b) of FIG. 11, the modified check item is indicated by hatching.

Furthermore, in the second row in individual rule E shown in (e) of FIG. 11, as to the rule that “communication access using VM4 as a source, VM2 as a destination, and logical router F as a forwarding destination is permitted”, rule modifier 12 modifies the check item to “encryption” so as to satisfy the above-described base policy specifying that “(c) communication access between trusted partitions is prohibited in plaintext (encryption is required)”. As a result, the second row in individual rule E is modified to specify a rule that “communication access using VM4 as a source, VM2 as a destination, and logical router F as a forwarding destination is prohibited in plaintext”. Furthermore, in the fifth row in individual rule E, as to the rule that “communication access using VM2 as a source, and VM4 as a destination and a forwarding destination is permitted”, rule modifier 12 modifies the check item in this rule to “decryption” so as to satisfy the above-described base policy specifying that “(c) communication access between trusted partitions is prohibited in plaintext (encryption is required)”. As a result, the fifth row in individual rule E is modified to specify a rule that “communication access using VM2 as a source, and VM4 as a destination and a forwarding destination is prohibited in plaintext”. Note that in each of the second row and the fifth row in individual rule E shown in (e) of FIG. 11, the modified check item is indicated by hatching.

Referring back to the flowchart of FIG. 2, the process proceeds to step S5 after step S7, and rule verifier 10 verifies again, based on the base policy, whether individual rules A to F shown in (a) to (f) of FIG. 11, respectively, which have been modified by rule modifier 12, satisfy the base policy (S5).

All of individual rules A to F shown in (a) to (f) of FIG. 11, respectively, satisfy the base policy. Therefore, all of individual rules A to F generated by rule generator 8 are verified by rule verifier 10 to satisfy the base policy (“OK” in S6).

In this case, determiner 14 outputs individual rules A to F to outputter 16 based on the verification results of rule verifier 10. Outputter 16 then outputs individual rules A to F received from determiner 14 to the outside of generation device 2 (S8). The process in the flowchart of FIG. 2 is then ended.

### 3. Advantageous Effects

In the present embodiment, rule verifier 10 verifies, based on the base policy, whether an individual rule generated by rule generator 8 satisfies the base policy as described above. When the individual rule is verified by rule verifier 10 not to satisfy the base policy, rule modifier 12 modifies, based on the base policy, the individual rule so as to satisfy the base policy. Rule verifier 10 then verifies whether the individual rule modified by rule modifier 12 satisfies the base policy.

In this manner, rule modifier 12 repeatedly modifies the individual rule until the individual rule is verified by rule verifier 10 to satisfy the base policy. As a result, individual rules that satisfy the base policy can be easily generated when designing or updating vehicle system 18.

### Other Variations

The generation device according to one or more aspects has been described above based on the above embodiment. However, the present disclosure is not limited to the above embodiment. Forms obtained by making various modifications to the above embodiment that can be conceived by those skilled in the art, as well as forms obtained by combining structural components in different embodiments, without materially departing from the spirit of the present disclosure, may be included in the scope of the one or more aspects.

In the above embodiment, when an individual rule is verified by rule verifier 10 not to satisfy the base policy, rule modifier 12 modifies the individual rule. However, when the number of times the individual rule is verified by rule verifier 10 not to satisfy the base policy reaches a predetermined number, rule modifier 12 may terminate the modification of the individual rule. This can avoid the modification of the individual rule from being needlessly repeated when the individual rule that satisfies the base policy cannot be generated, for example.

Furthermore, in step S4 in the flowchart of FIG. 2, the individual rules may be generated by Artificial Intelligence (AI).

Furthermore, when an individual rule is modified in step S7 in the flowchart of FIG. 2, the individual rule may be replaced by an existing individual rule rather than simply adding a check item.

Furthermore, in step S5 in the flowchart of FIG. 2, rule verifier 10 may also verify whether the number of tables or the number of check items is less than or equal to a predetermined number in addition to the violation of the base policy.

Furthermore, in step S8 in the flowchart of FIG. 2, not only a set of individual rules that completely satisfy the base policy, but also a set of individual rules that satisfy only part of the base policy may be outputted to the outside of generation device 2 together.

Note that in the above embodiment, each component may be configured as dedicated hardware or may be implemented by executing a computer program suitable for the component. Each component may be implemented by a program executer, such as a Central Processing Unit (CPU) or a processor, reading and executing a computer program recorded on a recording medium, such as a hard disk or a semiconductor memory.

Furthermore, some or all of the functions of the generation device according to each of the above embodiments may be implemented by a processor, such as a CPU, executing a computer program.

Some or all of the components included in each of the above devices may be configured as an IC card or a discrete module that can be attached to, and detached from, each device. Such an IC card or such a module is a computer system including a microprocessor, a ROM, a RAM, etc. The IC card or the module may include a highly multifunctional Large-Scale Integration (LSI) chip. The IC card or the module achieves its function as a result of the microprocessor operating according to a computer program. This IC card or this module may be tamper-resistant.

The present disclosure may be embodied in the method shown above. The present disclosure may also be embodied in a computer program that implements these methods by a computer, or a digital signal that includes the computer program. The present disclosure may also be embodied in the computer program or the digital signal recorded on a non-transitory computer-readable recording medium such as a flexible disk, a hard disk, a CD-ROM, an MO, a DVD, a DVD-ROM, a DVD-RAM, a Blu-ray (registered trademark) Disc (BD), or a semiconductor memory. The present disclosure may also be embodied in the digital signal recorded on these recording media. The present disclosure may also be embodied in the computer program or the digital signal transmitted via telecommunication lines, wireless or wired communication lines, networks notably including the Internet, data broadcasting, etc. The present disclosure may also be embodied in a computer system including a microprocessor and a memory. The memory may store the computer program, and the microprocessor may be configured to operate according to the computer program. The present disclosure may also be implemented by other independent computer systems by recording the computer program or the digital signal on the recording media and delivering such recording media, or by transferring the computer program or the digital signal via the networks, etc.

### FURTHER INFORMATION ABOUT TECHNICAL BACKGROUND TO THIS APPLICATION

The disclosure of the following patent application including specification, drawings, and claims is incorporated herein by reference in its entirety: Japanese Patent Application No. 2025-051327 filed on Mar. 26, 2025.

### INDUSTRIAL APPLICABILITY

For example, the generation device according to the present disclosure is applicable to the designing of vehicle architectures, etc.

1. A generation device comprising:
a rule generator that generates an individual rule about communication access between two partitions among a plurality of partitions into which a vehicle system is logically separated;
a rule verifier that verifies, based on a base policy about communication access in all of the plurality of partitions, whether the individual rule generated by the rule generator satisfies the base policy; and
a rule modifier that modifies the individual rule based on the base policy when the individual rule is verified by the rule verifier not to satisfy the base policy, wherein
when the individual rule is modified by the rule modifier, the rule verifier verifies whether the individual rule modified satisfies the base policy, and
the rule modifier repeatedly modifies the individual rule until the individual rule is verified by the rule verifier to satisfy the base policy.

2. The generation device according to claim 1, further comprising:
an outputter that outputs the individual rule to outside of the generation device when the individual rule is verified by the rule verifier to satisfy the base policy.

3. The generation device according to claim 1, wherein
when a total number of times the individual rule is verified by the rule verifier not to satisfy the base policy reaches a predetermined number, the rule modifier terminates the modification of the individual rule.

4. A generation method comprising:
(a) generating an individual rule about communication access between two partitions among a plurality of partitions into which a vehicle system is logically separated;
(b) verifying, based on a base policy about communication access in all of the plurality of partitions, whether the individual rule generated in (a) satisfies the base policy;
(c) modifying, when the individual rule is verified in (b) not to satisfy the base policy, the individual rule based on the base policy;
(d) verifying, when the individual rule is modified in (c), whether the individual rule modified satisfies the base policy; and
(e) repeatedly modifying the individual rule until the individual rule is verified to satisfy the base policy in (d).
